(19) United States
(12) Patent Application Publication
(10) Pub. No.: US 2003/0141622 A1
(43) Pub. Date: Jul. 31, 2003

(54) Windshield wiper apparatus and methods

(76) Inventor: Kenneth W. Winters, Renton, WA (US)

Correspondence Address: HEWLETT-PACKARD COMPANY, Intellectual Property Administration, P.O. Box 272400, Fort Collins, CO, 80527-2400, US

(21) Appl. No.: 10/058,361

(22) Filed: Jan. 28, 2002

(51) Int. Cl. B29C 37/00; B60S 1/38; B29C 37/02; B29C 67/00

(52) U.S. Cl. 264/138; 15/250.06; 15/250.07; 264/163

(57) ABSTRACT

Windshield wiper apparatus and methods in accordance with various embodiments of the instant invention include forming a new edge on a worn wiper blade. The new edge increases the effectiveness of the wiper blade and thus extends the useful life of the wiper blade. An apparatus in accordance with one embodiment of the instant invention can be employed to form the new edge in accordance with one of various methods including trimming a worn edge from the wiper blade as well as molding a new edge onto the worn wiper blade. In accordance with yet another embodiment of the instant invention, a windshield wiper assembly includes a wiper blade and a heating element supported on the windshield wiper assembly, wherein the heating element is configured to heat the wiper blade so as to keep the wiper blade substantially clear of ice, snow and the like during winter driving conditions.

### FIELD OF THE INVENTION

The invention claimed and disclosed herein pertains to windshield wiper apparatus and methods.

### BACKGROUND OF THE INVENTION

Various forms of prior art windshield wiper apparatus and methods have been in use nearly since the beginning of the twentieth century. Presently, prior art windshield wiper apparatus and methods are incorporated into various vehicles and land-based structures including automobiles, trucks, aircraft, water-borne vessels, control towers and the like. Prior art windshield apparatus are generally in the form of windshield wiper blades that are configured to sweep across a given surface in order to clear the given surface of light-inhibiting materials including water, snow, ice, condensation, dust, and the like. Generally, the given surface, for which the prior art windshield wiper apparatus is configured to clear, is a windshield comprising a layer of glass or other transparent material. The given surface can also be the lens of a headlight or the like. That is, prior art windshield wiper apparatus and methods are generally known to be employed for clearing other surfaces in addition to windshields.

Turning now to FIG. 1, an end view of a typical prior art windshield wiper apparatus 10 is shown. The prior art windshield wiper assembly 10 comprises a blade rail 12. The blade rail 12 is typically fabricated from a substantially rigid material such as injection-molded plastic or the like. Usually, a pair of opposed channels 16 are defined in the blade rail 12. The channels 16 serve to mount the blade rail 12 to a wiper arm (not shown) or the like. The blade rail 12 is generally supported on such a wiper arm which, in turn, is supported on an actuator assembly (not shown) or the like which is configured to move the wiper arm and blade rail across a surface to be cleared.

As is seen, the prior art windshield wiper apparatus 10 also comprises a wiper blade 14. The wiper blade 14 is generally mounted to the blade rail 12 and supported thereby. The wiper blade 14 is typically fabricated from a pliable, waterproof material such as rubber, vinyl, urethane, or the like. The prior art wiper blade 14 typically tapers down to terminate at an edge 17 that has well-defined corners 18. As is seen, the edge 17 is generally opposite the blade rail 12. As is also seen, the edge 17 of the prior art wiper blade 14 is substantially perpendicularly oriented relative to the remainder of the wiper blade. That is, the corners 18 of the prior art wiper blade 14 generally form right angles as is indicated by the angle marked “A.”

As mentioned above, the prior art wiper blade apparatus 10 is generally caused to be moved across a surface to be cleared (not shown) by an actuator assembly (not shown) or the like. The prior art wiper blade apparatus 10 is typically moved across the surface to be cleared in a lateral or transverse direction which is indicated by the double-ended arrow marked “P.” The prior art wiper blade apparatus 10 can be moved in either an alternating back-and-forth motion, or in a continuous one way motion wherein the wiper blade circulates in a repeating pattern.

As the prior art wiper blade apparatus 10 moves across the surface to be cleared, the wiper blade 14 deflects slightly so that one of the corners 18 impinges on the surface so as to clear it of water and the like. Moving now to FIG. 2, an end view of the prior art windshield wiper apparatus 10 is shown, wherein the wiper blade 14 is depicted in a substantially worn condition. That is, after a given amount of use the edge 17 of prior art windshield wiper apparatus 10 becomes somewhat rounded and devoid of well-defined corners 18 which are present on the unworn wiper blade 14 as can be seen by a study of FIG. 1. This rounding-off of the edge 17 as shown in FIG. 2 can be caused by abrasion due to the wiper blade 14 moving repeatedly across the surface to be cleared.

As is also seen in FIG. 2, the edge 17 of the wiper blade 14 can develop cracks 19 and other surface defects and the like which are due to exposure of the wiper blade over time to environmental elements such as solar radiation, extreme temperature changes, and the like. The worn condition of the prior art wiper blade 14 often renders the blade ineffective for adequately clearing windshields and the like of vision-inhibiting materials such as water. Additionally, even in cases wherein the prior art wiper blade 14 is not substantially worn, the wiper blade can often become clogged with excessive amounts of ice and snow during winter weather conditions. Such clogging of the prior art wiper blade 14 with ice and snow often renders the blade ineffective in clearing windshields.

What are needed then are windshield wiper apparatus and methods which achieve the benefits to be derived from similar prior art apparatus and methods, but which avoid the shortcomings and detriments individually associated therewith.

### SUMMARY OF THE INVENTION

The instant invention includes windshield wiper apparatus and methods. In accordance with one embodiment of the instant invention, an apparatus for revitalizing a windshield wiper blade includes an edge-former and a guide. The edge-former can be configured in one of a number of possible manners to form a new edge on a worn windshield wiper blade. The guide acts to maintain the wiper blade in substantial alignment with the edge-former while the new edge is formed on the blade.

In accordance with another embodiment of the instant invention, a windshield wiper apparatus comprises a windshield wiper assembly that includes a wiper blade. The apparatus also includes at least one heating element that is supported on the windshield wiper assembly and that is configured to heat the wiper blade. The heating element can be embedded within the wiper blade in one configuration of the apparatus. The windshield wiper assembly can also comprise a blade rail to which the wiper blade is mounted. In accordance with another configuration of the apparatus, the heating element can be supported on the blade rail. Likewise, the windshield wiper assembly can include a wiper arm on which the wiper blade is supported. The heating element can alternatively be supported on the wiper arm.

In accordance with yet another embodiment of the instant invention, a method of revitalizing a windshield wiper blade includes the step of forming a new edge on the wiper blade by trimming a worn edge there from. The method can also include trimming the wiper blade at an oblique angle as well as applying a protective material to the wiper blade. A similar method of revitalizing a windshield wiper blade in accordance with still another embodiment of the present invention includes forming a new edge on the wiper blade by molding the wiper blade. The method can also include the step of softening at least a portion of the wiper blade to a plastic state.

These and other aspects and embodiments of the present invention will now be described in detail with reference to the accompanying drawings, wherein:

### DESCRIPTION OF THE DRAWINGS

FIG. 1 is an end view depicting a typical prior art windshield wiper blade assembly having a substantially unworn edge.

FIG. 2 is an end view depicting a typical prior art windshield wiper blade assembly having a substantially worn edge.

FIG. 3 is an end view depicting a revitalized windshield wiper blade assembly in accordance with the instant invention, wherein a normal new edge has been formed.

FIG. 4 is an end view depicting a revitalized windshield wiper blade assembly in accordance with the instant invention, wherein an oblique new edge has been formed.

FIG. 5 is a windshield wiper revitalization apparatus in accordance with one embodiment of the instant invention.

FIG. 6 is a windshield wiper apparatus in accordance with another embodiment of the instant invention.

### DETAILED DESCRIPTION OF THE INVENTION

The instant invention includes windshield wiper apparatus and methods. In accordance with one embodiment of the instant invention a method includes revitalizing worn windshield wiper blades by forming a new edge thereon. The new edge can be formed by trimming a worn edge from the wiper blade, or by molding a new edge onto the wiper blade. An apparatus in accordance with another embodiment of the instant invention can be employed to perform such revitalization methods for forming a new edge on a wiper blade. In accordance with yet another embodiment of the instant invention, a windshield wiper apparatus includes a windshield wiper assembly and a heating element supported on the wiper assembly and configured to heat a wiper blade that is included in the windshield wiper assembly.

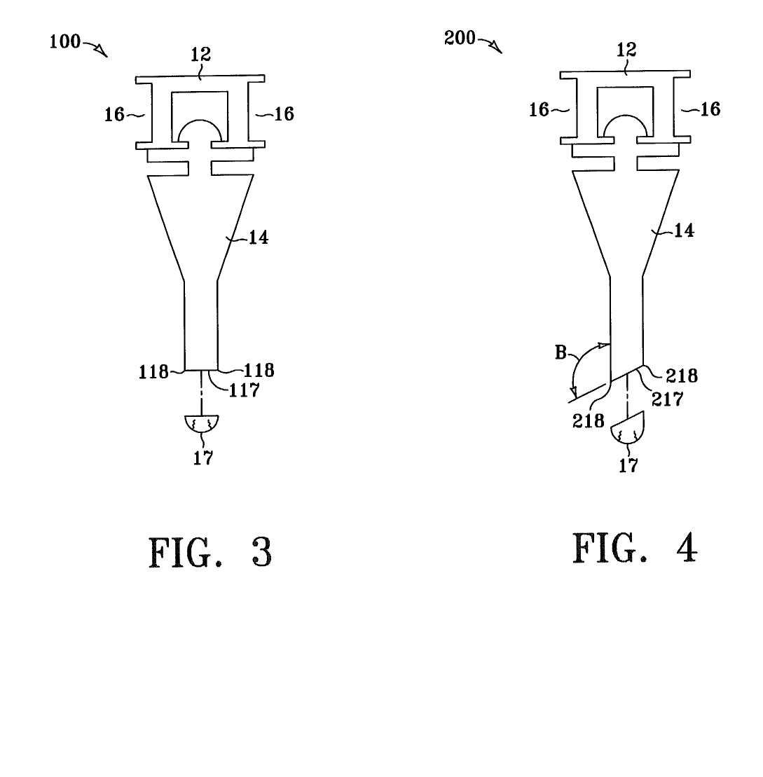

Turning now to FIG. 3, an end view is shown which depicts a windshield wiper apparatus 100 in accordance with one embodiment of the instant invention. The windshield wiper apparatus 100 can comprise a blade rail 12 which has been described above with respect to the prior art. The blade rail 12 preferably defines at least one channel 16. The channel 16 has also been described above with respect to the prior art. As is seen in FIG. 3, the windshield wiper apparatus 100 comprises a windshield wiper blade 14. The wiper blade 14 has been described above with respect to the prior art. Thus, the windshield wiper apparatus 100 in accordance with one embodiment of the instant invention can comprise a prior art wiper blade 14 as well as a prior art blade rail 12.

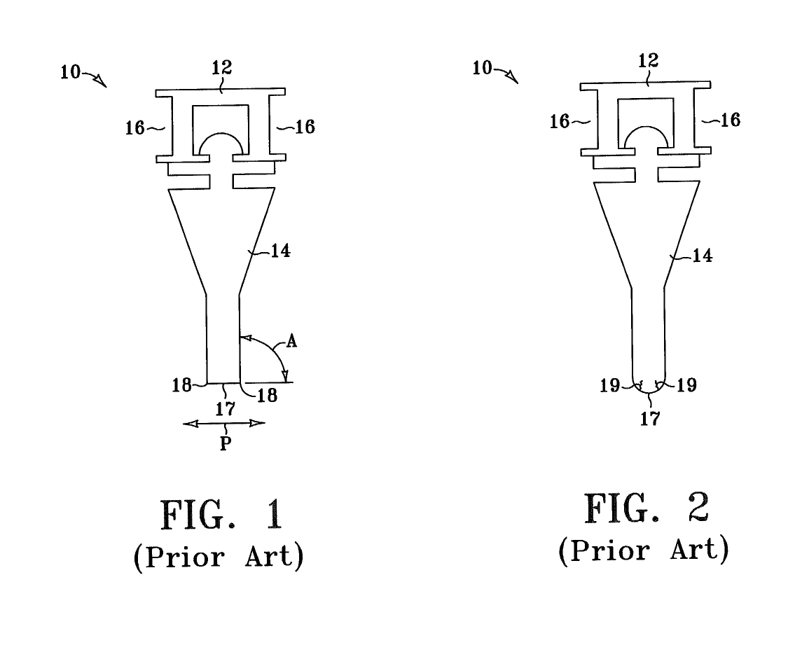

However, as is evident from a study of FIG. 3, the windshield wiper apparatus 100 can be differentiated from similar prior art apparatus by the new edge 117 formed on the wiper blade 14. As is also seen, at least one new corner 118 can also be formed on the wiper blade 14. The new edge 117 and the new corner 118 are formed by trimming the wiper blade 14. The term “trimming” as used herein with respect to a wiper blade means to sever and remove at least a portion of the edge of the wiper blade so as to form a new edge thereon. Thus, the new edge 117 and new corner 118 are formed on the wiper blade 14 by removing the worn edge 17 from the wiper blade 14 as shown. As is further seen, the new edge 117 can be formed on the wiper blade 14 so as to be substantially perpendicular relative to the remainder of the wiper blade as explained with respect to the prior art windshield apparatus 10 shown in FIG. 1. That is, the new corner 118 can be formed so as to be a substantially right angle corner.

The worn edge 17 can be trimmed or removed from the wiper blade 14 by any of a number of known methods including cutting, grinding, burning, shearing, and the like. Apparatus for trimming the wiper blade 14 will be discussed below in further detail. As an alternative to trimming the blade 14, the new edge 117 and new corner 118 can be formed by molding. The term “molding” as used herein with respect to a wiper blade means to soften at least a portion of the edge of the wiper blade to at least a plastic state, whereupon the softened blade portion is shaped and before being solidified back into its original non-plastic state. The process of molding various materials, including those of which the wiper blade 14 is comprised, is known in the art and can include the process of heating such materials to a plastic state.

Moving now to FIG. 4, an end view is shown which depicts a windshield wiper apparatus 200 in accordance with another embodiment of the instant invention. As is evident, the windshield wiper apparatus 200 can be substantially similar to the apparatus 100 which is described immediately above with respect to FIG. 3. However, the windshield wiper apparatus 200 which is shown in FIG. 4 is distinguishable from other windshield wiper apparatus in that an oblique new edge 217 is formed on the respective wiper blade 14.

That is, the oblique new edge 217 is formed on the respective wiper blade 14 by trimming the worn edge 17 from wiper blade at an oblique angle. In other words, at least one new oblique edge 218 is formed thereon which is either substantially less than, or substantially greater than 90 degrees, as is indicated by the angle “B.” The oblique new edge 217 can be formed by any of the means of forming the perpendicular new edge 117 which are discussed above with respect to FIG. 3. The obliqueness of the new edge 217 as well as the corners 218 can provide advantages over perpendicular edges and corners in certain conditions.

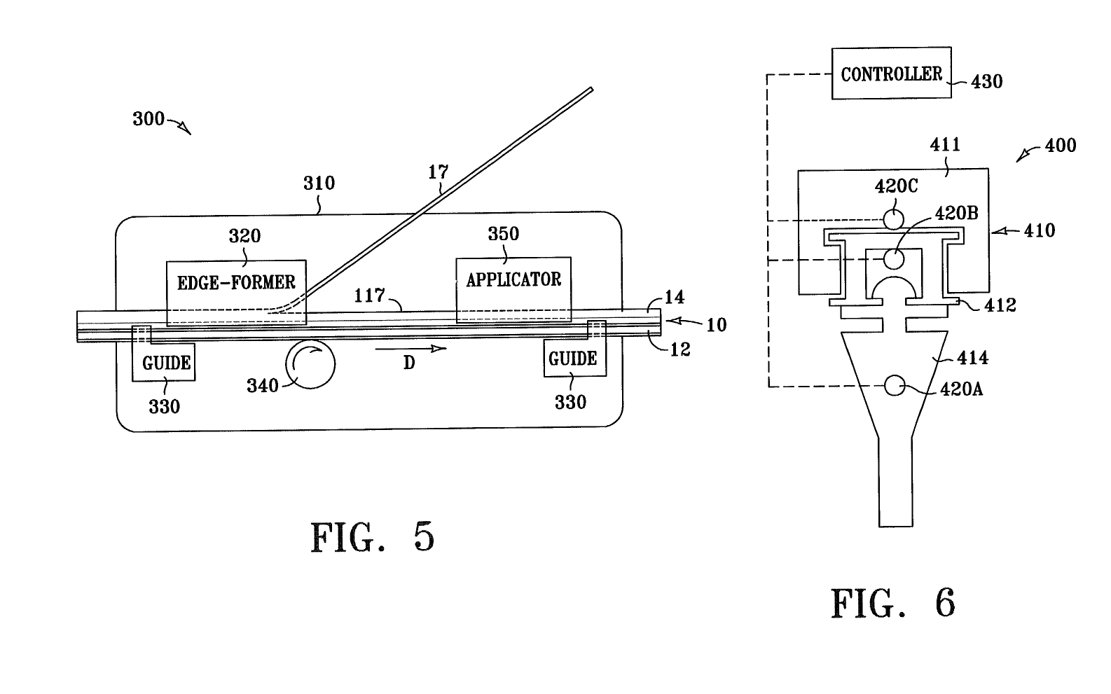

Moving now to FIG. 5, a top view of a simplified schematic diagram is shown which depicts a windshield wiper blade revitalization apparatus 300. As is seen, the apparatus 300 can be used for revitalizing at least a portion of a windshield wiper assembly 10. As discussed above, the windshield wiper assembly 10 typically comprises a wiper blade 14 that is mounted to a blade rail 12. Thus, the apparatus 300 can be configured to revitalize the wiper blade 12. The term “revitalize” as used herein means to process so as to increase the effectiveness of. That is, the windshield wiper blade revitalization apparatus 300 is configured to process the wiper blade 14 so as to increase the effectiveness of the wiper blade.

One of the processes that the apparatus 300 can be configured to perform is that of forming a new edge 117 on the wiper blade 14. That is, the apparatus 300 can be configured to form a new edge 117 on the wiper blade 14 by removing the old edge 17 as discussed above with respect to FIGS. 3 and 4. Such a new edge 117 can be formed on the wiper blade by the apparatus 300 by way of various processes such as trimming the worn edge 17 to form the new edge, and/or by molding a new edge. The processes of trimming the worn edge 17 as well as those of molding or otherwise forming the new edge 117 have been discussed above with respect to FIGS. 3 and 4.

It is understood that FIG. 5 is a simplified schematic diagram that depicts the various components of the apparatus 300 as “black boxes.” That is, the general means individually employed and embodied by each of the respective components schematically represented by the labeled symbols of FIG. 5 are assumed to be simple enough to be understandable by way of the written description contained herein in conjunction with the schematic diagram provided in FIG. 5. Therefore, it is understood that complex mechanical drawings of the individual components are assumed to be unnecessary for the understanding of the invention and are thus not included herein.

With reference to FIG. 5, the apparatus 300 comprises an edge-former 320. The edge-former 320 is configured to form the new edge 117 on the windshield wiper blade 14 by any of a number of manners. That is, the edge-former 320 can be configured in one of several manners which are discussed in greater detail below. For example, the edge-former 320 can be configured as a trimmer which removes the worn edge 17 from the wiper blade 14 to form the new edge 117 as discussed above with respect to FIGS. 3 and 4. Alternatively, the edge-former 320 can be configured as a molder which molds the new edge 117 on the wiper blade 14 by a molding process as described above with respect to FIGS. 3 and 4.

In the case wherein the edge-former 320 is configured as a trimmer, various trimming means can be employed to remove the worn edge from the wiper blade 14 to form a new edge thereon. That is, the edge-former 320 can be configured as one of various possible types of trimmers. For example, the edge-former 320 can be a cutting device having a blade (not shown) or the like that is configured to remove the worn edge 17 from the wiper blade 14 by a cutting or slicing process.

Alternatively, the edge-former 320 can be a grinding device having a grinding surface (not shown) or the like that is configured to remove the worn edge 17 from the wiper blade 14 by a grinding or abrading process. The edge-former 320 can also be a laser device configured to generate a laser beam (not shown) or the like that is configured to remove the worn edge 17 from the wiper blade 14. The edge-former 320 can also be a fluid jet device that is configured produce a high-pressure, concentrated jet stream of liquid (not shown) to remove the worn edge from the wiper blade 14. For example, the fluid jet device can utilize water as a fluid. As yet another alternative, the edge-former 320 can be a shearing device having a shearing blade (not shown) that is configured to remove the worn edge from the wiper blade 14 using a shearing process. For example, shearing processes are routinely used in the prior art for severing metal sheets and plates as well as other materials.

As is seen from a study of FIG. 5, the apparatus 300 comprises a guide 330. Preferably, the apparatus 300 comprises a plurality of guides 330. The guide 330 is configured to maintain alignment of the wiper blade 14 relative to the edge-former 320. Preferably, the guide 330 is configured to engage at least one channel 16 (shown in FIGS. 3 and 4) of the blade rail 12 to maintain alignment of the wiper blade 14. The guide 330 can also be configured to contact the wiper blade 14 itself in order to maintain alignment of the wiper blade relative to the edge-former 320.

Preferably, both the edge-former 320 and the guide 330 are supported on a frame 310 that provides a common structural support or chassis for the edge-former and the guide. As is also seen, the apparatus 300 can be configured to allow the windshield wiper assembly 10 to be moved through the apparatus in conjunction with the edge-forming process. For example, the windshield wiper apparatus 300 can be configured to allow the windshield wiper assembly 10 to be moved through the apparatus in the direction indicated by the arrow D.

That is, preferably, the windshield wiper assembly 10 can be moved through the apparatus 300 in the direction indicated by the arrow D while the new edge 117 is formed on the wiper blade 14. However, it is understood that the apparatus 300 can be configured so as to allow the windshield wiper assembly 10 to be moved in directions other that those indicated by the arrow D. For example, the apparatus 300 can be configured to allow the windshield wiper assembly 10, in conjunction with the forming of the new blade edge 117, to be moved relative to the apparatus in a direction that is substantially perpendicular to the direction indicated by the arrow D.

As is further evident from a study of FIG. 5, the apparatus 300 can comprise a feeder 340. The feeder 340 can comprise at least one roller (not shown) or gripping devices (not shown) that are configured to move the windshield wiper assembly 10 relative to the edge-former 320. That is, the feeder 340 is configured to assist in the edge-forming process by moving the wiper blade 14 relative to the edge-former 320 so that the edge-former can form the new edge 117 along the length of the wiper blade. Preferably, the feeder 340 is supported by the frame 310 along with the edge-former 320 and the guide 330.

However, the feeder 340 can be configured to function in one of a number of possible manners. For example, in one possible configuration, the feeder 340 is supported on the frame 310, and the edge-former 320 is supported on the feeder. In this configuration, the feeder 340 moves the edge-former 320 relative to the frame 310. Thus, in such a configuration, the guide 330 preferably maintains the wiper blade 14 in a substantially stationary alignment relative to the frame 310 while the feeder 340 moves the edge-former 320 relative to the wiper blade.

In another possible configuration, the edge-former 320 is supported on the frame 310 in a substantially stationary position relative thereto. In this configuration, the feeder 340 is also supported on the frame 310 and is configured to move the wiper blade 14 relative thereto. The guide 330, in such a configuration, can either be supported on the frame 310 in a substantially stationary position relative thereto, or be supported on the feeder 340 so as to be substantially stationary relative to the wiper blade 14. Thus, in this configuration, the feeder 340 is configured to move the wiper blade 14 relative to the edge-former 320 and to the frame 310, while the feeder and edge-former remain substantially stationary relative to the frame.

As is further seen in FIG. 5, the apparatus 300 can comprise an applicator 350. The applicator 350 is preferably supported on the frame 310. The applicator 350 is configured to apply a protective material to the wiper blade 14 in conjunction with the formation of a new edge thereon. Protective materials applied by the applicator 350 can include various known products. These known products are generally used as protective materials and cleaners for rubber, vinyl, plastic and the like. Such products are marketed under various trade names which include, for example, Armor All® which is available from the Armor All Products Corporation. The protective material can be applied to the wiper blade 14 by the applicator 350 in any of a number of manners such as by dipping, wiping, spraying, and the like. The protective material is preferably applied by the applicator 350 to the wiper blade 14 after the new edge 117 is formed by the edge-former 320.

In operation, a worn wiper blade 14 can be fed, or placed, into the apparatus 300. The apparatus 300 can then be activated so as to cause the edge-former 320 to form a new edge 117 on the wiper blade 14. The apparatus 300 can be configured so that the wiper blade 14 is automatically fed through the apparatus by way of the feeder 340, and wherein the edge-former 320 automatically forms the new edge 117 on the wiper blade. Alternatively, the apparatus 300 can be configured without a feeder 340 so that the blade 14 is manually fed through the apparatus by the operator. As a further alternative, the apparatus 300 can be configured so that the blade 14 is manually positioned on or within the apparatus, wherein the edge-former 320 automatically forms the new edge 117 on the blade while the blade remains in a substantially stationary position. Also, if configured with an applicator 350, the apparatus 300 can be configured to automatically apply a protective material to the blade 14.

As a further alternative, the apparatus 300 can be configured as a stationary unit that is intended to remain in a fixed location while operational. Alternatively, the apparatus 300 can be configured to be substantially portable so as to be conveniently mobile. Furthermore, the apparatus 300 can be relatively small in size so as to facilitate its use as a hand-held device. The apparatus 300 can also be configured to operate from alternative power sources. That is, for example, in the case wherein the apparatus is a portable, hand-held unit, it is preferably configured to draw operational power from a portable battery (not shown) that is preferably supported on the apparatus itself. Alternatively, the apparatus 300 can be configured to operate draw electrical current from an electrical power grid such as a household electrical power distribution system (not shown), or the electrical system of a vehicle (not shown).

Moving now to FIG. 6, an end view is shown which depicts a windshield wiper apparatus 400 in accordance with yet another embodiment of the instant invention. The windshield wiper apparatus 400 is configured to provide increased performance by adding heat energy to various portions of the windshield wiper assembly 410. The windshield wiper assembly 410 comprises a windshield wiper blade 414. The wiper blade 414 can be substantially similar to the prior art wiper blade 14, which is shown and described herein with respect to FIGS. 1 and 2, with the exception of the differences specifically described herein.

The windshield wiper assembly 410 can also comprise a blade rail 412. The blade rail 412 can be substantially similar to the prior blade rail 12, which is shown and described herein with respect to FIGS. 1 and 2, with the exception of the differences specifically described herein. The blade rail 412 is preferably mounted to the wiper blade 414 as is described above for the prior art blade rail 12 and prior art wiper blade 14. The windshield wiper assembly 410 can also comprise a wiper arm 411. The windshield wiper arm 411 can be similar to prior art windshield wiper arms (not shown) with the exception of the features of the windshield wiper arm in accordance with the instant invention which are specifically described herein. The wiper arm 411 is preferably configured to be supported on an actuator (not shown) or the like that can move the windshield wiper assembly 410 across a surface to be cleared (not shown) such as a windshield or the like.

Still referring to FIG. 6, the windshield wiper apparatus 400 additionally comprises a heating element 420A, 420B, 420C. It is understood that the alphabetic suffixes of “A,” “B,” and “C” denote some of the various alternative positions of the heating element. That is, in one configuration of the apparatus 400, the heating element 420A can be embedded within the wiper blade 414 as shown. In another alternative configuration of the apparatus 400, the heating element 420B can be supported on the blade rail 412, wherein the blade rail is configured to support the heating element. As yet another alternative configuration of the apparatus 400, the heating element 420C can be supported on the wiper arm 411, wherein the wiper arm is configured to support the heating element.

In other words, the apparatus 400 can comprise, embedded within the wiper blade 414, a single heating element 420A. Alternatively, the apparatus 400 can comprise, supported on the blade rail 412, a single heating element 420B. As yet a further alternative, the apparatus 400 can comprise, supported on the wiper arm 411, a single heating element 420C. However, it is understood that the apparatus 400 can comprise a plurality of heating elements 420A, 420B, and 420C as well. For example, the apparatus 400 in yet another alternative configuration can comprise a pair of heating elements 420A, 420B which are located on the windshield wiper assembly 410 as indicated above with respect to the individual respective components 414 and 412.

In any case, the heating element 420A, 420B, 420C is configured to heat the wiper blade 414 so as to prevent ice, snow, and/or other contaminants from building up thereon. The prevention of the build up of ice, snow, and/or other contaminants on the wiper blade 414 can provide increased performance of the wiper blade during cold-weather operations. As is further seen in FIG. 6, the apparatus 400 can comprise a controller 430. The controller 430 is preferably connected to the respective heating element(s) 420A, 420B, 420C, and is configured to control the temperature of the respective heating element(s).

In one preferred configuration of the apparatus 400, electrical current is supplied to the respective heating element(s) 420A, 420B, 420C, wherein the electrical current is converted to heat energy by the heating element(s). Preferably, in such an embodiment, the amount of electrical energy supplied to the respective heating element(s) 420A, 420B, and 420C is controlled by the controller 430 so as to control the amount of heat energy created thereby. The controller 430 can be configured to control the amount of heat created by the respective heating element(s) 420A, 420B, 420C in conjunction with a feedback control loop (not shown) or the like which can be configured to assist the controller in maintaining the temperature of the heating element(s) within a given temperature range. Feedback control loops are known in the art and need not be discussed further herein.

In accordance with yet another embodiment of the instant invention, a method of revitalizing a windshield wiper blade comprises forming a new edge on the blade by trimming a worn edge there from. For example, an apparatus such as the windshield wiper apparatus 300 which is described above with reference to FIG. 5 can be employed for trimming a worn edge from a wiper blade in order to form a new edge thereon. The wiper blade can be trimmed at a substantially perpendicular angle, or can alternatively be trimmed at an oblique angle. Another step in accordance with this embodiment of the instant invention is to apply a protective material to the wiper blade. This step can be performed using the apparatus 300, wherein the apparatus includes an applicator 350 as described above.

In accordance with still another embodiment of the instant invention, a method of revitalizing a windshield wiper blade comprises forming a new edge on the wiper blade by molding the wiper blade. This step can also be performed, for example, by using the windshield wiper apparatus 300 which is described above with respect to FIG. 5. The method in accordance with this embodiment of the instant invention can also include softening at least a portion of the wiper blade to a plastic state. The softening of the portion of the windshield wiper blade can be accomplished by heating the wiper blade, for example. When the respective portion of the wiper blade is softened, the softened portion can be molded. Preferably, the softened portion of the wiper blade, once molded, is then substantially solidified into its original state prior to softening.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. An apparatus for revitalizing a windshield wiper blade, comprising:
an edge-former that is configured to form a new edge on the windshield wiper blade;
a guide configured to maintain substantial alignment of the windshield wiper blade relative to the edge-former.

2. The apparatus of claim 1, wherein the edge-former is a trimmer.

3. The apparatus of claim 1, wherein the edge-former is a cutting device.

4. The apparatus of claim 1, wherein the edge-former is a grinding device that is configured to form the new edge.

5. The apparatus of claim 1, wherein the edge-former is a laser device that is configured to form the new edge.

6. The apparatus of claim 1, and wherein the edge-former is a fluid jet assembly that is configured to form the new edge.

7. The apparatus of claim 6, and wherein the fluid jet is a water jet.

8. The apparatus of claim 1, wherein the edge-former is a shearing device that is configured to form the new edge.

9. The apparatus of claim 1, wherein the edge-former is a molder.

10. The apparatus of claim 1, and further comprising a frame on which both the edge-former and the guide are supported.

11. The apparatus of claim 1, and further comprising a feeder configured to move the windshield wiper blade relative to the edge-former.

12. The apparatus of claim 11, and further comprising a frame on which the feeder is supported, wherein the feeder is configured to support the edge-former and to move the edge-former relative to the frame.

13. The apparatus of claim 12, and wherein the guide is supported on the frame.

14. The apparatus of claim 11, and further comprising a frame on which the feeder, the edge-former, and the guide are supported, wherein the feeder is configured to move the windshield wiper blade relative to the frame.

15. The apparatus of claim 1, and further comprising an applicator configured to apply a protective material to the windshield wiper blade.

16. The apparatus of claim 1, wherein the apparatus is configured to be portable.

17. The apparatus of claim 16, and wherein the apparatus is further configured to draw operational power from a portable battery.

18. The apparatus of claim 1, wherein the apparatus is configured to be hand-held.

19. A windshield wiper apparatus, comprising:
a windshield wiper assembly that includes a wiper blade; and
a heating element which is supported on the windshield wiper assembly and which is configured to heat the wiper blade.

20. The windshield wiper apparatus of claim 19, and wherein the heating element is embedded within the wiper blade.

21. The apparatus of claim 19, and further comprising a blade rail on which the wiper blade is supported, wherein the heating element is supported on the blade rail.

22. The apparatus of claim 19, and further comprising a wiper arm on which the wiper blade is supported, wherein the heating element is supported on the wiper arm.

23. The apparatus of claim 19, and further comprising a controller connected to the heating element and configured to control the temperature of the heating element.

24. A method of revitalizing a wiper blade, comprising forming a new edge on the wiper blade by trimming a worn edge there from.

25. The method of claim 24, and wherein the wiper blade is trimmed at an oblique angle.

26. The method of claim 24, and further comprising applying a protective material to the wiper blade.

27. A method of revitalizing a windshield wiper blade, comprising forming a new edge on the wiper blade by molding the new edge.

28. The method of claim 27, and further comprising softening at least a portion of the wiper blade to a plastic state.

29. The method of claim 28, and wherein the wiper blade is softened by heating the wiper blade.
